(19) United States
(12) Patent Application Publication
(10) Pub. No.: US 2006/0049683 A1
(43) Pub. Date: Mar. 9, 2006

(54) Safety rail assembly

(75) Inventor: Fu-Fu Hsieh, Luzhu Shiang (TW)

Correspondence Address: NIKOLAI & MERSEREAU, P.A., 900 SECOND AVENUE SOUTH, SUITE 820, MINNEAPOLIS, MN, 55402, US

(73) Assignee: GE Shine Industries Corp., Kaohsiung Hsien (TW)

(21) Appl. No.: 11/204,248

(22) Filed: Aug. 15, 2005

(30) Foreign Application Priority Data
Sep. 9, 2004 (TW) 093214550

(51) Int. Cl. B60R 22/18

(52) U.S. Cl. 297/473

(57) ABSTRACT

A safety rail assembly includes two fixing seats each secured to a wall, a mounting tube mounted between the two fixing seats, and a fixing rod mounted in the mounting tube and secured to the two fixing seats. Thus, the safety rail assembly is assembled and disassembled easily and rapidly, thereby facilitating a user assembling and disassembling the safety rail assembly. In addition, the whole length of the safety rail assembly is increased or shortened arbitrarily according to the user's practical requirement, so that the safety rail assembly is available for users of different statures.

### BACKGROUND OF THE INVENTION

1. Field of the Invention

The present invention relates to a safety rail assembly, and more particularly to a safety rail assembly mounted on a wall to provide a safe support effect to a user.

2. Description of the Related Art

A conventional safety rail is mounted on a wall so that a user's one hand can hold the safety rail to obtain a support efficiently. The closest prior art reference of which the applicant is aware was disclosed in the Taiwanese Patent Application No. 87220049, entitled by “Anti-Skid Safety Rail”. However, the conventional anti-skid safety rail has a complicated construction with too many parts, thereby increasing cost of fabrication. In addition, the conventional anti-skid safety rail has a fixed length and cannot be lengthened to satisfy the user's practical requirement, thereby limiting the versatility of the conventional anti-skid safety rail.

### SUMMARY OF THE INVENTION

In accordance with the present invention, there is provided a safety rail assembly, comprising two fixing seats each secured to a wall, a mounting tube mounted between the two fixing seats, and a fixing rod mounted in the mounting tube and secured to the two fixing seats.

The primary objective of the present invention is to provide a safety rail assembly mounted on a wall to provide a safe support effect to a user.

Another objective of the present invention is to provide a safety rail assembly that is assembled and disassembled easily and rapidly, thereby facilitating a user assembling and disassembling the safety rail assembly.

A further objective of the present invention is to provide a safety rail assembly, wherein the whole length of the safety rail assembly is increased or shortened arbitrarily according to the user's practical requirement, so that the safety rail assembly is available for users of different statures.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a safety rail assembly in accordance with the preferred embodiment of the present invention.

FIG. 2 is an exploded perspective view of the safety rail assembly as shown in FIG. 1.

FIG. 3 is a plan cross-sectional view of the safety rail assembly as shown in FIG. 1.

FIG. 4 is a perspective view of a safety rail assembly in accordance with another preferred embodiment of the present invention.

FIG. 5 is an exploded perspective view of the safety rail assembly as shown in FIG. 4.

FIG. 6 is a plan cross-sectional view of the safety rail assembly as shown in FIG. 4.

FIG. 7 is a plan cross-sectional assembly view of the safety rail assembly taken along line 7-7 as shown in FIG. 6.

FIG. 8 is a plan cross-sectional assembly view of the safety rail assembly taken along line 8-8 as shown in FIG. 6.

FIG. 9 is a plan view of a safety rail assembly in accordance with another preferred embodiment of the present invention.

FIG. 10 is a plan view of a safety rail assembly in accordance with another preferred embodiment of the present invention.

FIG. 11 is a perspective view of a safety rail assembly in accordance with another preferred embodiment of the present invention.

FIG. 12 is an exploded perspective view of a safety rail assembly in accordance with another preferred embodiment of the present invention.

### DETAILED DESCRIPTION OF THE INVENTION

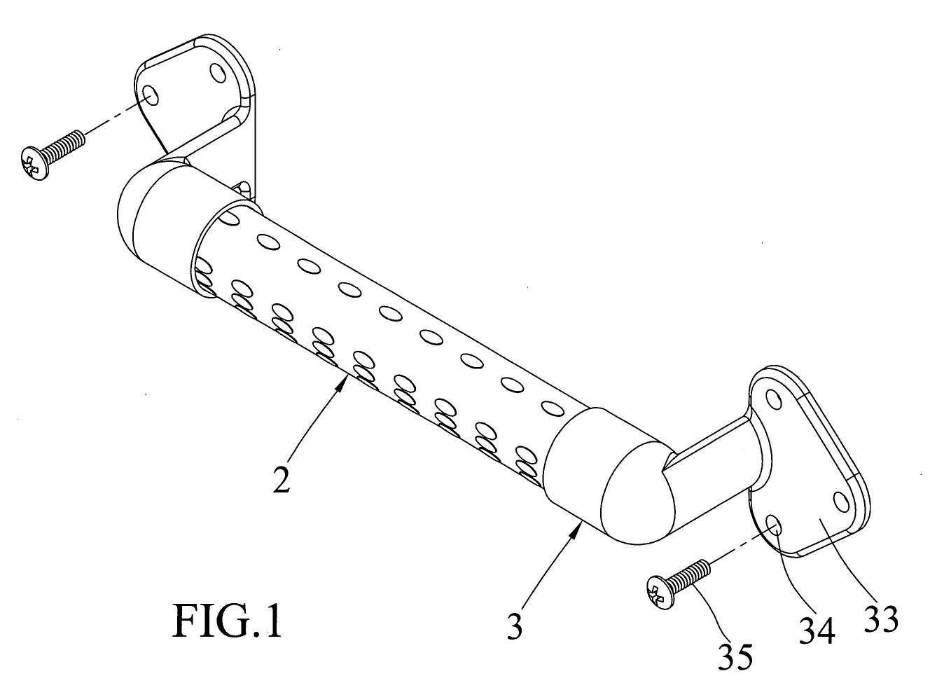

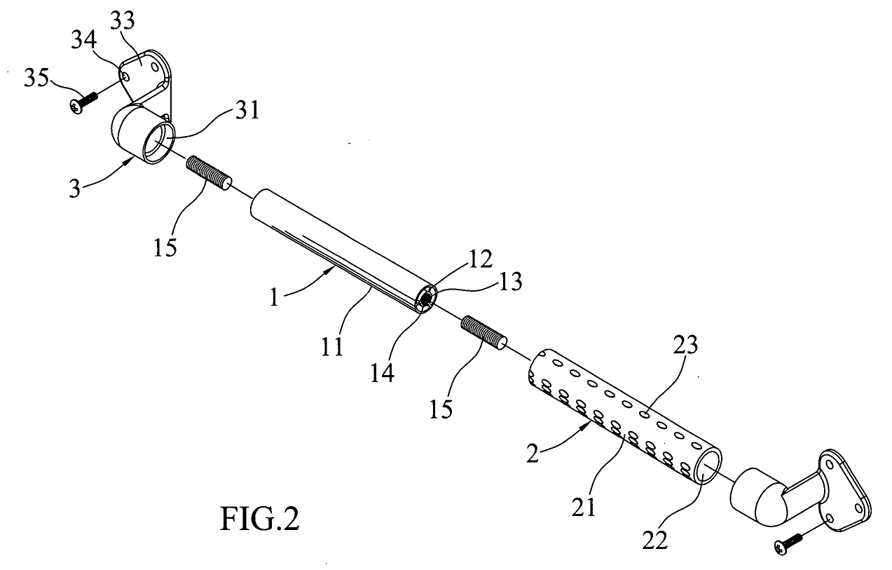

Referring to the drawings and initially to FIGS. 1-3, a safety rail assembly in accordance with the preferred embodiment of the present invention comprises two fixing seats 3 each secured to a wall 5, a mounting tube 2 mounted between the two fixing seats 3, and a fixing rod 1 mounted in the mounting tube 2 and secured to the two fixing seats 3.

The fixing rod 1 has an outer tube 11 mounted in the mounting tube 2, an inner tube 13 disposed in the outer tube 11, and a plurality of connecting ribs 12 connected between the inner tube 13 and the outer tube 11. The inner tube 13 of the fixing rod 1 has two ends each formed with an inner thread 14. The fixing rod 1 is secured to the two fixing seats 3 by two threaded rod 15.

The mounting tube 2 has an inner wall formed with a mounting hole 22 for mounting the fixing rod 1 and an outer wall 21 formed with a plurality of protrusions 23 to provide an anti-slip effect.

Each of the two fixing seats 3 has a first portion formed with a stepped receiving recess 31 to allow insertion of the mounting tube 2 and the fixing rod 1. The receiving recess 31 of each of the two fixing seats 3 has an inner thread 32, and each of the two threaded rod 15 has a first end screwed into the respective inner thread 14 of the inner tube 13 of the fixing rod 1 and a second end screwed into the inner thread 32 of the receiving recess 31 of the respective fixing seat 3. Each of the two fixing seats 3 has a second portion formed with a fixing plate 33 secured to the wall 5 by a plurality of locking screws 35. The fixing plate 33 of each of the two fixing seats 3 has a plurality of fixing holes 34 to allow passage of the locking screws 35.

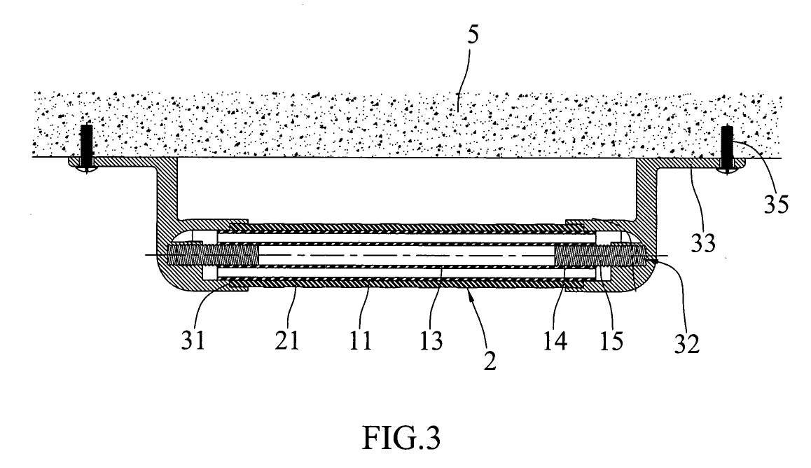

Thus, as shown in FIG. 3, the safety rail assembly is attached to the wall 5 so that a user can hold the safety rail assembly to provide a safety support effect.

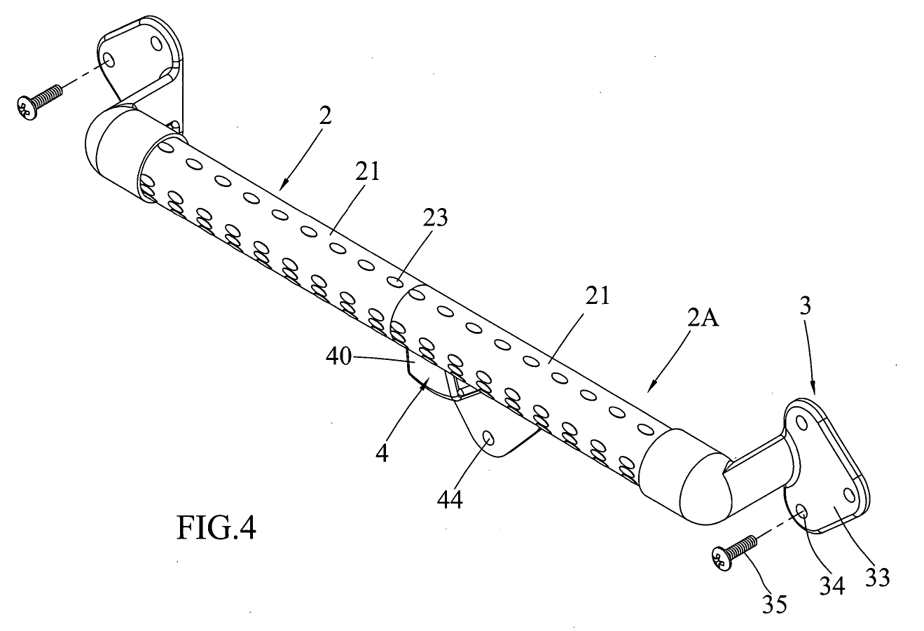

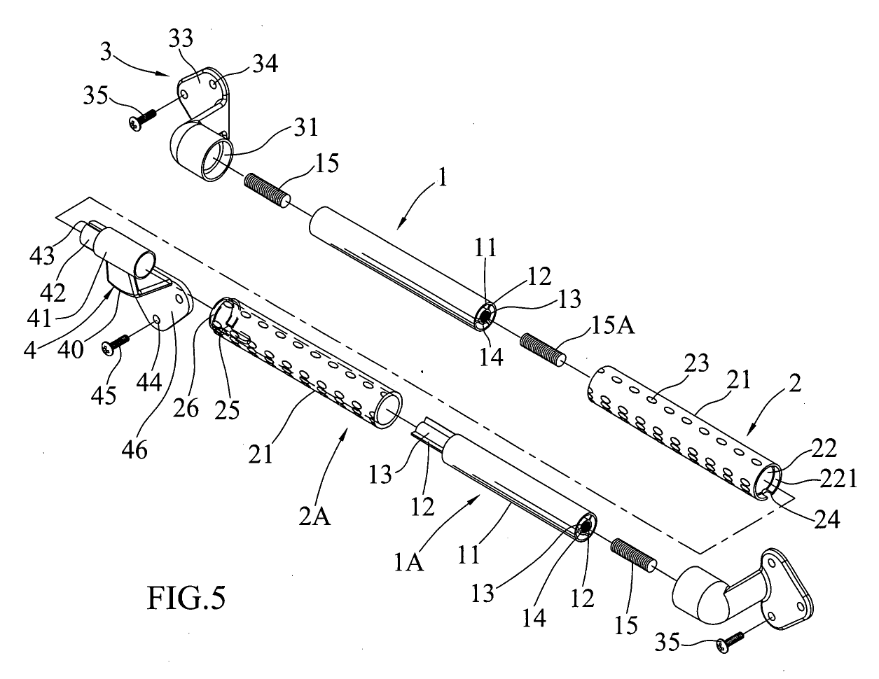

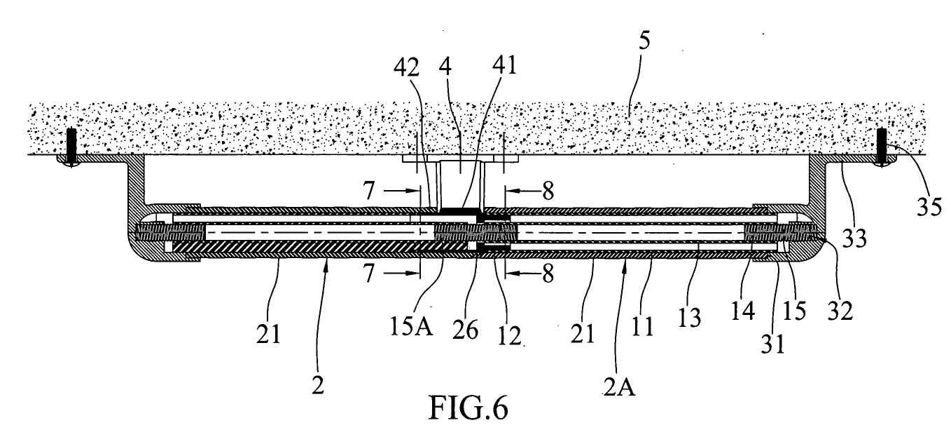

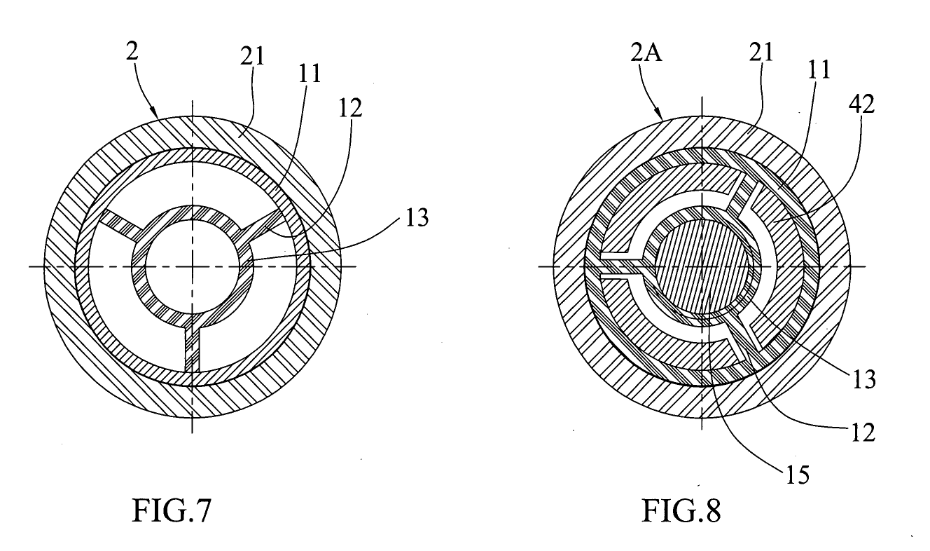

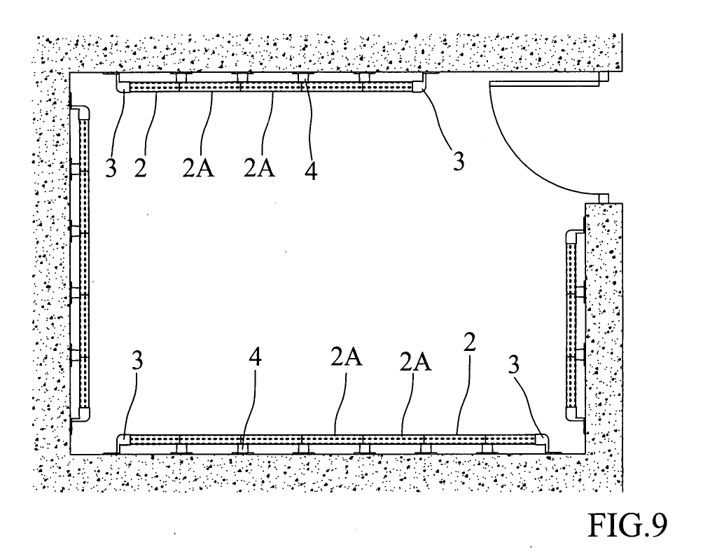

Referring to FIGS. 4-8, the safety rail assembly further comprises a secondary mounting tube 2A juxtaposed to the mounting tube 2 so that the mounting tube 2 and the secondary mounting tube 2A are mounted between the two fixing seats 3, a secondary fixing rod 1A mounted in the secondary mounting tube 2A and juxtaposed to the fixing rod 1, and a secondary fixing seat 4 mounted between the mounting tube 2 and the secondary mounting tube 2A to support the mounting tube 2 and the secondary mounting tube 2A.

The mounting hole 22 of the mounting tube 2 has an end portion formed with a retaining groove 221 and a receiving slot 24.

The secondary mounting tube 2A has s structure similar to that of the mounting tube 2. The secondary mounting tube 2A has an end portion formed with a reduced flange 26 inserted into the retaining groove 221 of the mounting tube 2 and an elongated slot 25 connected to the receiving slot 24 of the mounting tube 2.

The secondary fixing rod 1A has s structure similar to that of the fixing rod 1. The secondary fixing rod 1A has an outer tube 11 mounted in the secondary mounting tube 2A, an inner tube 13 disposed in the outer tube 11, and a plurality of connecting ribs 12 connected between the inner tube 13 and the outer tube 11. The inner tube 13 and the connecting ribs 12 at one end of the secondary fixing rod 1A are exposed outward from the outer tube 11 and juxtaposed to one end of the fixing rod 1. The inner tube 13 of the secondary fixing rod 1A has two ends each formed with an inner thread 14. The secondary fixing rod 1A is secured to the fixing rod 1 by a secondary threaded rod 15A. The secondary threaded rod 15A has a first end screwed into the respective inner thread 14 of the inner tube 13 of the fixing rod 1 and a second end screwed into the respective inner thread 14 of the inner tube 13 of the secondary fixing rod 1A.

Each of the two threaded rod 15 has a first end screwed into the respective inner thread 14 of the inner tube 13 of the fixing rod 1 or the respective inner thread 14 of the inner tube 13 of the secondary fixing rod 1A and a second end screwed into the inner thread 32 of the receiving recess 31 of the respective fixing seat 3.

The secondary fixing seat 4 has a base portion 40 mounted in the receiving slot 24 of the mounting tube 2 and the elongated slot 25 of the secondary mounting tube 2A, a fixing tube 41 formed on a first portion of the base portion 40 and mounted on the exposed inner tube 13 and connecting ribs 12 at one end of the secondary fixing rod 1A, an insertion tube 42 extended from one end of the fixing tube 41 and inserted into the outer tube 11 of the fixing rod 1, and a fixing plate 46 formed on a second portion of the base portion 40 and secured to the wall 5 by a plurality of locking screws 45. The fixing plate 46 of the secondary fixing seat 4 has a plurality of fixing holes 44 to allow passage of the locking screws 45. The insertion tube 42 of the secondary fixing seat 4 has a plurality of rib slots 43 to allow insertion of the connecting ribs 12 of the fixing rod 1.

Thus, the mounting tube 2 and the secondary mounting tube 2A increase the length of the safety rail assembly, so that the whole length of the safety rail assembly is axially extended outward.

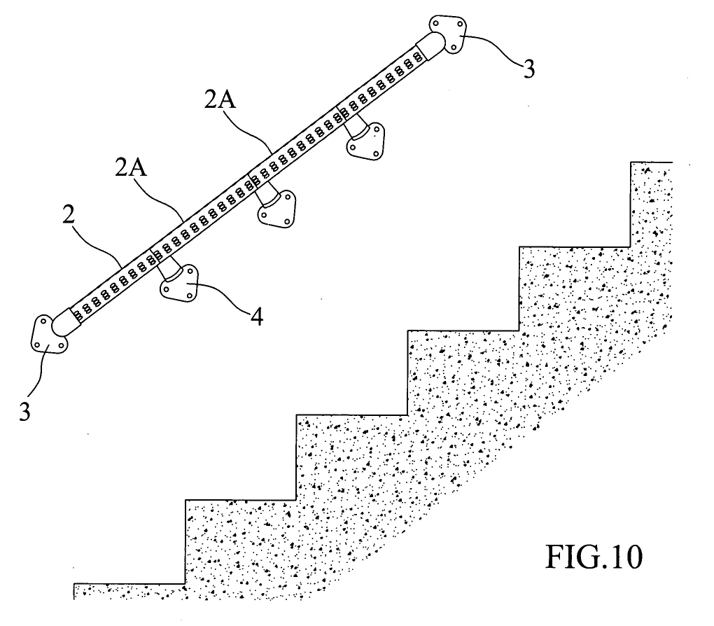

Referring to FIGS. 9 and 10, the safety rail assembly further comprises a plurality of juxtaposed secondary mounting tubes 2A juxtaposed to the mounting tube 2 so that the mounting tube 2 and the secondary mounting tubes 2A are mounted between the two fixing seats 3. Thus, the mounting tube 2 and the secondary mounting tubes 2A increase the length of the safety rail assembly, so that the whole length of the safety rail assembly is axially extended outward.

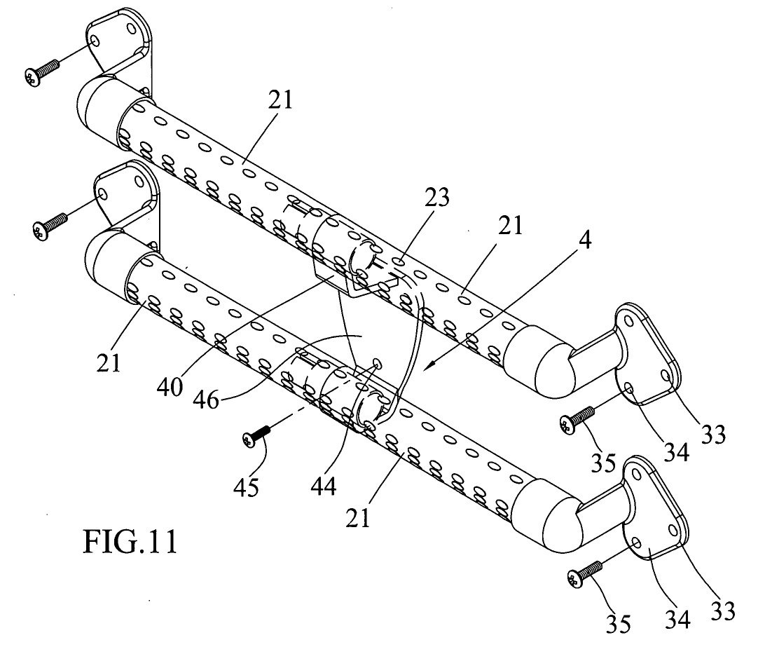

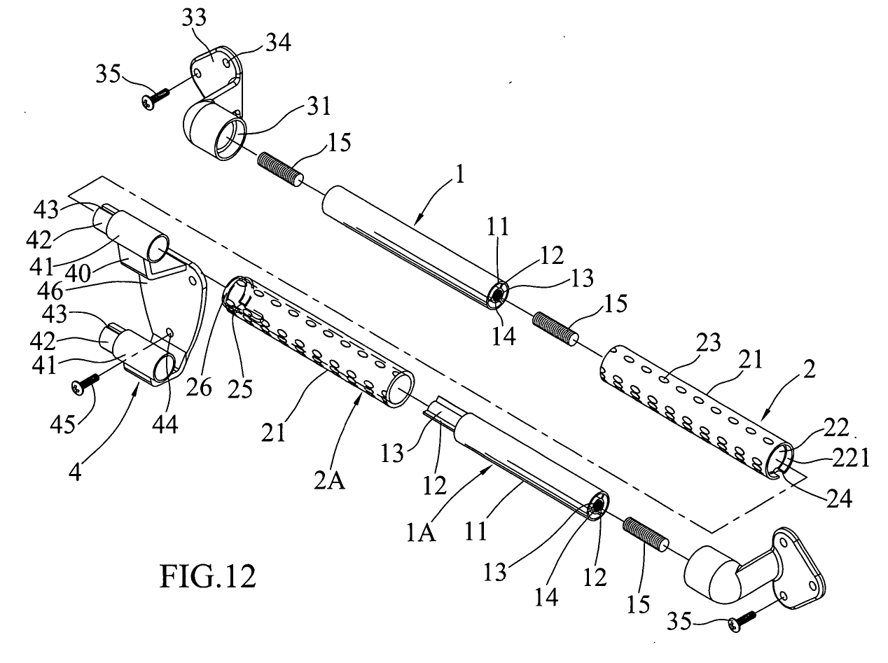

Referring to FIGS. 11 and 12, the secondary fixing seat 4 has two opposite fixing tubes 41 and two opposite insertion tubes 42.

Accordingly, the safety rail assembly is assembled and disassembled easily and rapidly, thereby facilitating a user assembling and disassembling the safety rail assembly. In addition, the whole length of the safety rail assembly is increased or shortened arbitrarily according to the user's practical requirement, so that the safety rail assembly is available for users of different statures and requirements.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A safety rail assembly, comprising:
two fixing seats each secured to a wall;
a mounting tube mounted between the two fixing seats;
a fixing rod mounted in the mounting tube and secured to the two fixing seats.

2. The safety rail assembly in accordance with claim 1, wherein the fixing rod has an outer tube mounted in the mounting tube, an inner tube disposed in the outer tube, and a plurality of connecting ribs connected between the inner tube and the outer tube.

3. The safety rail assembly in accordance with claim 1, wherein the mounting tube has an inner wall formed with a mounting hole for mounting the fixing rod.

4. The safety rail assembly in accordance with claim 1, wherein the mounting tube has an outer wall formed with a plurality of protrusions to provide an anti-slip effect.

5. The safety rail assembly in accordance with claim 2, wherein each of the two fixing seats has a first portion formed with a stepped receiving recess to allow insertion of the mounting tube and the fixing rod.

6. The safety rail assembly in accordance with claim 5, wherein the fixing rod is secured to the two fixing seats by two threaded rod.

7. The safety rail assembly in accordance with claim 6, wherein the inner tube of the fixing rod has two ends each formed with an inner thread, the receiving recess of each of the two fixing seats has an inner thread, and each of the two threaded rod has a first end screwed into the respective inner thread of the inner tube of the fixing rod and a second end screwed into the inner thread of the receiving recess of the respective fixing seat.

8. The safety rail assembly in accordance with claim 5, wherein each of the two fixing seats has a second portion formed with a fixing plate secured to the wall by a plurality of locking screws.

9. The safety rail assembly in accordance with claim 8, wherein the fixing plate of each of the two fixing seats has a plurality of fixing holes to allow passage of the locking screws.

10. The safety rail assembly in accordance with claim 1, further comprising a secondary mounting tube juxtaposed to the mounting tube so that the mounting tube and the secondary mounting tube are mounted between the two fixing seats, a secondary fixing rod mounted in the secondary mounting tube and juxtaposed to the fixing rod, and a secondary fixing seat mounted between the mounting tube and the secondary mounting tube to support the mounting tube and the secondary mounting tube.

11. The safety rail assembly in accordance with claim 10, wherein the secondary mounting tube has s structure similar to that of the mounting tube.

12. The safety rail assembly in accordance with claim 10, wherein the mounting tube has an end portion formed with a retaining groove, and the secondary mounting tube has an end portion formed with a reduced flange inserted into the retaining groove of the mounting tube.

13. The safety rail assembly in accordance with claim 10, wherein the secondary fixing rod has s structure similar to that of the fixing rod.

14. The safety rail assembly in accordance with claim 10, wherein the secondary fixing rod has an outer tube mounted in the secondary mounting tube, an inner tube disposed in the outer tube, and a plurality of connecting ribs connected between the inner tube and the outer tube.

15. The safety rail assembly in accordance with claim 14, wherein the mounting tube has an end portion formed with a receiving slot, the secondary mounting tube has an end portion formed with an elongated slot connected to the receiving slot of the mounting tube, the inner tube and the connecting ribs at one end of the secondary fixing rod are exposed outward from the outer tube and juxtaposed to one end of the fixing rod, and the secondary fixing seat has a base portion mounted in the receiving slot of the mounting tube and the elongated slot of the secondary mounting tube, a fixing tube formed on a first portion of the base portion and mounted on the exposed inner tube and connecting ribs at one end of the secondary fixing rod, an insertion tube extended from one end of the fixing tube and inserted into the fixing rod, and a fixing plate formed on a second portion of the base portion and secured to the wall by a plurality of locking screws.

16. The safety rail assembly in accordance with claim 15, wherein the fixing plate of the secondary fixing seat has a plurality of fixing holes to allow passage of the locking screws.

17. The safety rail assembly in accordance with claim 15, wherein the fixing rod has an outer tube mounted in the mounting tube, an inner tube disposed in the outer tube, and a plurality of connecting ribs connected between the inner tube and the outer tube, and the insertion tube of the secondary fixing seat has a plurality of rib slots to allow insertion of the connecting ribs of the fixing rod.

18. The safety rail assembly in accordance with claim 14, wherein the fixing rod and the secondary fixing rod are secured to the two fixing seats by two threaded rod, the secondary fixing rod is secured to the fixing rod by a secondary threaded rod, the inner tube of the secondary fixing rod has two ends each formed with an inner thread, the secondary threaded rod has a first end screwed into the respective inner thread of the inner tube of the fixing rod and a second end screwed into the respective inner thread of the inner tube of the secondary fixing rod, and each of the two threaded rod has a first end screwed into the respective inner thread of the inner tube of the fixing rod or the respective inner thread of the inner tube of the secondary fixing rod and a second end screwed into the inner thread of the receiving recess of the respective fixing seat.

19. The safety rail assembly in accordance with claim 1, further comprises a plurality of juxtaposed secondary mounting tubes juxtaposed to the mounting tube so that the mounting tube and the secondary mounting tubes are mounted between the two fixing seats.

20. The safety rail assembly in accordance with claim 15, wherein the secondary fixing seat has two opposite fixing tubes and two opposite insertion tubes.
